(19) United States
(12) Patent Application Publication
(10) Pub. No.: US 2025/0194858 A1
(43) Pub. Date: Jun. 19, 2025

(54) MULTIFUNCTIONAL FOOD CONTAINER

(71) Applicant: TZU-HSUAN CHUANG, New Taipei City (TW)

(72) Inventor: TZU-HSUAN CHUANG, New Taipei City (TW)

(21) Appl. No.: 18/977,887

(22) Filed: Dec. 11, 2024

(30) Foreign Application Priority Data
Dec. 15, 2023 (TW) 112149095

(51) Int. Cl. A47J 43/24

(52) U.S. Cl. CPC A47J 43/24

(57) ABSTRACT

A multifunctional food container includes a food container and a drain container. An upper edge of the food container includes a high edge portion, a plurality of oblique edge portions, and a low edge portion having a height lower than the high edge portion. At least one layered portion is provided on the bottom of the food container includes an upper layer and a lower layer. A drain container is positionable in the food container. The drain container includes a layout area between an upper edge thereof and the upper edge of the food container. A plurality of first drainage holes are formed in the layout area, and a plurality of second drainage holes is formed in the bottom of the drain container. Food, when disposed into the food container, is supported on the upper layer, and waste water is collected in the lower layer.

### BACKGROUND OF THE INVENTION

### (a) Technical Field of the Invention

The present invention relates to a multifunctional food container which is easy to separate for use, effectively avoids secondary contamination of food, provides freedom of arrangement with respect to shape, quantity, and position of drainage holes in fabrication, is not easy for fruits and vegetables to fall out from an upper edge of a drain container, and a highly visual aesthetic design as a whole.

### (b) Description of the Prior Art

Modern people have an increasing demand for being health and thus often buy vegetables and fruits to cook at home. However, vegetables and fruits still contain certain amounts of pesticide residues to some extent and thus, for washing and cleaning, a drain basket is often used for easy cleaning and to allow the waste water to directly drain away through drainage holes in the underside of the drain basket after cleaning. Yet, the washed and cleaned vegetables and fruits still need to be placed in another container to dry the vegetables and fruits in order to avoid residual water on the surface. As such, two containers must be used to complete the cleaning and placement of vegetables and fruits.

Some manufacturers have also developed a container that has both a draining function and a storage function, such as patent document M430229 “Cleaning Container with Antibacterial Effect”, which includes a cleaning container and a drain basket. The cleaning container includes a storage space and an opening in communication with the storage space. At least one drainage hole is arranged near the opening. The drain basket is nestable in the cleaning container, and an outer surface of the drain basket is penetrated by multiple flow holes. Although this technology combines the drain basket and the cleaning container into one, during a cleaning process of fruits and vegetables, because the drainage hole is closer to the opening at the upper edge, the fluid may not be discharged in time during the course of discharging, so that part of the fluid still overflows to the edge of the opening, causing the fruits and vegetables to fall out. Moreover, after the fruits and vegetables are washed, the fruits and vegetables are still kept in the cleaning container for drying, but the bottom of the cleaning container does not involve a dry/wet separation design, so that the residual water originally remaining on the surfaces of the fruits and vegetables will slowly flow into and also bring certain amount of dirty water to the bottom of the cleaning container and accumulate at the bottom to cause secondary contamination of the fruits and vegetables. In addition, because the drainage hole of the cleaning container is located near the opening, the layout, shape, and number of the drainage holes are limited, and the manufacturing freedom is not good. From the perspective of separate use, the upper edge of the cleaning container is placed in tight engagement with the upper edge of the cleaning container, so that at the time when it is desired to have them separated, it is not easy to achieve separation and subsequent use. Fingernails or other tools must be used to dig into the gap between the upper edges of the two to separate them. This often leads to inconveniences, such as breaking of nails or use of additional tools, which in turn affect the consumers' experience and thus affects product sales. In addition, the dull and toneless appearance is not good for the overall visual sense, and this indirectly destroys the beauty of the home interior space.

### SUMMARY OF THE INVENTION

The primary objective of the present invention is provided for advantages of no secondary contamination being caused on food, the shape or quantity or position for the arrangement of first drainage holes being of extremely great freedom, food not falling out from an upper edge of a drain container, a user being allowed to freely select and use a food container or a drain container to achieve the purpose of being multifunctional, obliquely arranged first drainage holes showing a smooth visual sense arrangement to echo each other with respect to oblique edge portions, and allowing a user to easily separating a food container and a drain container by means of a layout area.

The main structure that the present invention adopts to achieve the above-described primary objective comprises a food container, the food container having an upper edge that includes a high edge portion, a plurality of oblique edge portions formed by respectively extending from two ends of the high edge portion toward a side opposite to the high edge portion, and a low edge portion formed at an intersection of each of the oblique edge portions, the low edge portion having a height lower than the high edge portion, at least one the layered portion being formed on a bottom of an interior of the food container, the layered portion comprising an upper layer and a lower layer arranged below the upper layer, the lower layer being arranged for collecting waste water that remains after food is washed, and further, a drain container is positionable on an upper layer of the layered portion, a layout area being formed on the drain container between an upper edge thereof and the upper edge of the food container, a plurality of first drainage holes being formed in the layout area, a plurality of second drainage holes being formed in the bottom. As such, in a condition of washing food, water will be discharged out from the first drainage holes and will not be discharged from the upper edge of the drain container, so that food will not fall out from the upper edge of the drain container and the food can be effectively protected. The residual water remaining on the surface of the food is allowed to freely fall into the lower layer, making the food on the upper layer not contaminated by the residual water in the lower layer to cause secondary contamination. Further, a user is allowed to individually use the food container or individually use the drain container as a drain basket, and is also allowed to combine the food container and the drain container together for use to realize a function of both draining and containing, that is an advantage of being multifunctional.

Further, most foods (such as fruits and vegetables) are grown with pesticides to protect the foods from influences of pests and diseases so as to improve the quality of product. However, for human body, pesticides are poisonous. Although washing and cleaning are performed before eating, some of the pesticides themselves will still remain on the surface, leading to accidental ingestion. Although the impact on human health is insignificant in the short term, accumulation over a long period of time can become a killer to health for issues of causing death of the central nervous system and leading to decreased immunity of various organs in the body. Therefore, researches have shown that for an attempt to completely remove pesticides, the best way is to rinse with running water for a long time, and try to avoid soaking food without running water. If the water is not changed and the food is soaked continuously, the surface of the food with a higher concentration of pesticides is disposed in the water and will cause secondary contamination of the food by pesticides. With the features of the present invention, the food is placed in the drain container, and then the water source is turned on to rinse the food. Under this condition, as the first drainage holes are arranged in the layout area, the first drainage holes can be formed in a variety of locations, especially being formed at a position far away from the upper edge of the drain container, so that the water source can be discharged from the drain container earlier, forming a concept of flowing water, that is, after rinsing the food, the water source can be quickly drained through the first drainage holes. And, correspondingly, the pesticides on the surface of the food can also be taken away from the drain container by the water source, so that the pesticides will not remain in the drain container. In this way, the food is not easy to fall out from the upper edge of the drain container, and the user can rest assured to let the food continue to be rinsed with running water for a long time. The water source, when discharged from the first drainage holes, may take away the residual pesticides, so as to effectively clean away the pesticides on the surface of the food.

By using the above technology, the problems of the conventional object cleaning containers with antibacterial effects, such as fruits and vegetables being easy to fall out, easy secondary contamination, poor freedom, difficulty in separating and taking out, and dull appearance, can be overcome, thereby achieving the practical progress of the above advantages of the present invention.

### BRIEF DESCRIPTION OF THE DRAWINGS

FIG. 1 is a perspective view of a first preferred embodiment of the present invention.

FIG. 2 is a cross-sectional view of the first preferred embodiment of the present invention taken along line A-A.

FIG. 3 is a schematic view showing use of the first preferred embodiment of the present invention.

FIG. 4 is a schematic view showing implementation of a second preferred embodiment of the present invention.

FIG. 5 is a schematic view showing implementation of a third preferred embodiment of the present invention.

FIG. 6 is a schematic view showing implementation of a fourth preferred embodiment of the present invention.

FIG. 7 is a schematic view showing implementation of a fifth preferred embodiment of the present invention.

FIG. 8 is a schematic view showing implementation of a sixth preferred embodiment of the present invention.

FIG. 9 is a perspective view of a seventh preferred embodiment of the present invention.

FIG. 10 is a side elevational view of the seventh preferred embodiment of the present invention.

FIG. 11 is an exploded view of the seventh preferred embodiment of the present invention.

FIG. 12 is a schematic view of the seventh preferred embodiment of the present invention illustrating washing.

FIG. 13 is a schematic view of the seventh preferred embodiment of the present invention illustrating draining.

FIG. 14 is a schematic view of the seventh preferred embodiment of the present invention illustrating separating.

FIG. 15 is a schematic view showing a drain container of an eighth preferred embodiment of the present invention.

FIG. 16 is a schematic view showing a drain container of a ninth preferred embodiment of the present invention.

FIG. 17 is a schematic view showing a drain container of a tenth preferred embodiment of the present invention.

FIG. 18 is a perspective view of an eleventh preferred embodiment of the present invention.

FIG. 19 is an exploded view of the eleventh preferred embodiment of the present invention.

FIG. 20 is a schematic view showing a layered portion of a twelfth preferred embodiment of the present invention.

FIG. 21 is schematic view showing a stabilizing portion of a thirteenth preferred embodiment of the present invention.

### DETAILED DESCRIPTION OF THE PREFERRED EMBODIMENTS

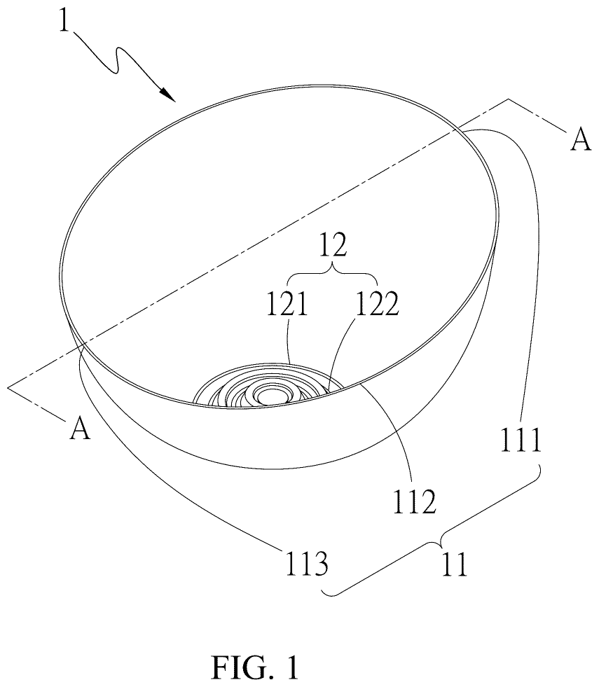

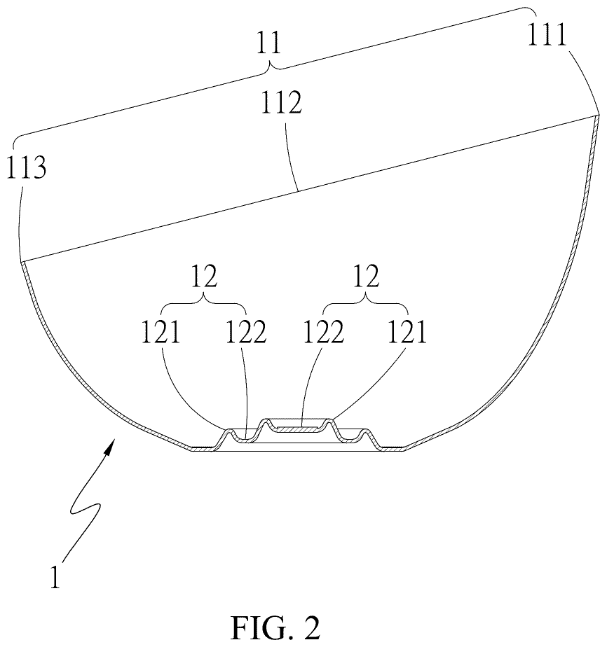

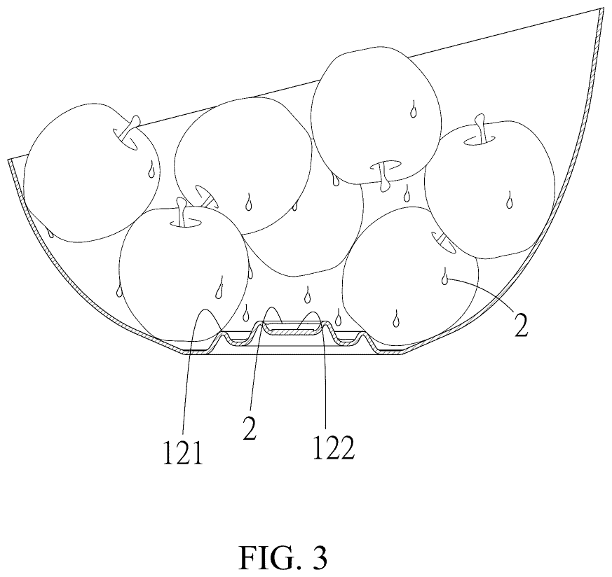

Referring to FIGS. 1-3, which are respectively a perspective view of a first preferred embodiment of the present invention, a cross-sectional view of the first preferred embodiment of the present invention taken along line A-A, and a schematic view showing use of the first preferred embodiment of the present invention, it is clearly seen from the drawings that the present invention comprises:
a food container 1, wherein the food container 1 has an upper edge 11, the upper edge 11 comprising a high edge portion 111, a plurality of oblique edge portions 112 formed by respectively extending from two ends of the high edge portion 111 toward a side opposite to the high edge portion 111, and a low edge portion 113 formed at an intersection of each of the oblique edge portions 112, the low edge portion 113 having a height lower than the high edge portion 111; and
at least one layered portion 12, which is formed on a bottom of an interior of the food container 1, the layered portion 12 comprising an upper layer 121 that supports food thereon and a lower layer 122 arranged below the upper layer 121, the lower layer 122 being arranged for collecting waste water that remains after the food is washed.

In the above, the food container 1 and the layered portion 12 being integrally formed as a one-piece structure is taken in the instant embodiment.

In the above, a shape that the layered portion 12 may present is not limited, and multiple circular ribs being taken as an example of the layered portion 12 in the instant embodiment, but a grid configuration formed through intersecting each other is also feasible, both being within the scope of the claims of the present invention. Further, the upper layer 121 is defined by an area of a ridge region of the layered portion 12, while the lower layer 122 is defined by an area of a valley region of the layered portion 12.

In the above, the food can be vegetables, fruits, or other foods that needs to be dried, and fruits are taken as an example in the instant embodiment.

As such, a user, desired to use the food container 1 to hold fruits, may directly place the fruits into the food container 1 through an opening on the top thereof so as to be received and held by the upper layer 121 of the layered portion 12. Further, the fruits themselves may have pesticides or other contaminations carried thereon, and under this condition, residual water 2 remaining on the fruits naturally flows from surfaces of the fruits toward the lower layer 122 at the bottom of the food container 1. As such, a separation arrangement is formed where the fruits are in the upper layer 121, while the residual water 2 is in the lower layer 122, making the fruits not contaminated by the residual water 2 that may potentially contain pesticides or other contaminants. Further, the residual pesticides may evaporate less with the ambient temperature and time. The longer the time of being placed still, the more complete the evaporation of the pesticides. Therefore, through the separation arrangement between the upper layer 121 and the lower layer 122 of the layered portion 12, during the course of the fruits being placed still, in addition that the fruits are not contaminated by the residual water that may potentially contain pesticides or other contaminants to cause secondary contamination, the pesticides are allowed to naturally evaporate and thus be removed during the course, so that the fruit can be eaten more safely and healthier for the human body.

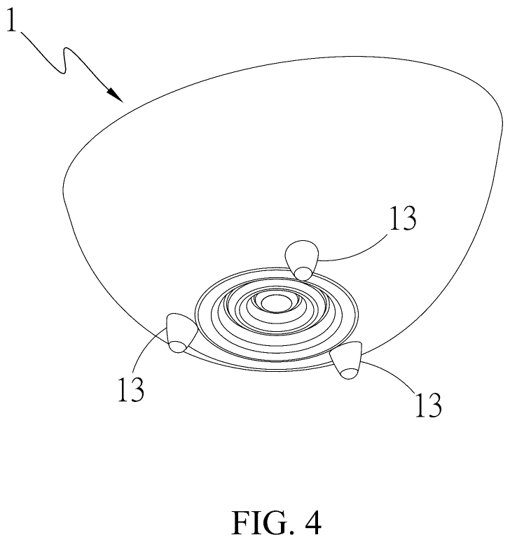

Referring to FIG. 4, which is a schematic view showing implementation of a second preferred embodiment of the present invention, it is clearly seen from the drawing that the instant embodiment is different from the first preferred embodiment in that in the instant embodiment, a bottom of an outside of the food container 1 is provided with at least one stabilizing portion 13, and three are taken as an example in the instant embodiment. Obviously, in case that the food container 1 is filled with food, if there is no arrangement of the stabilizing portion 13, the food container 1 may become unstable, especially in the case that a tabletop is uneven, it is more likely to fall over. Therefore, the food container 1 possesses an advantage of being stable and not falling over by means of the arrangement of the stabilizing portion 13.

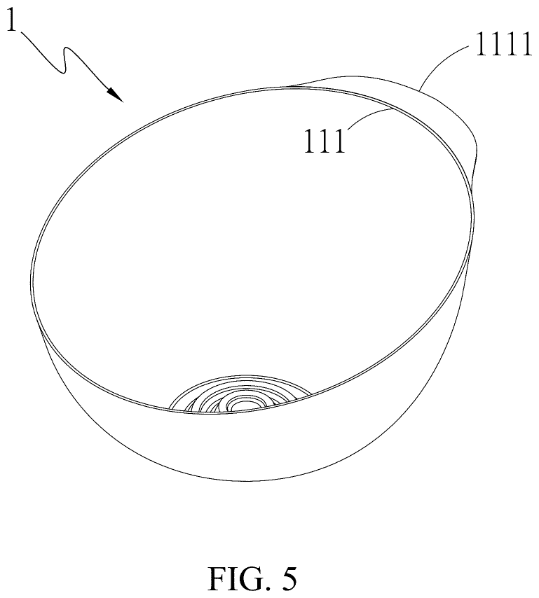

Referring to FIG. 5, which is a schematic view showing implementation of a third preferred embodiment of the present invention, it is clearly seen from the drawing that the instant embodiment is different from the first preferred embodiment in that in the instant embodiment, the high edge portion 111 is provided with a high edge handle portion 1111. The high edge handle portion 1111 is a planar surface formed by extending the high edge portion 111 toward one side, so that with the arrangement of the high edge handle portion 1111, a user, when attempting to take the food container 1, may take the food container 1 without having a hand reach to an inside surface thereof. Overall, it is not only easier to take, but also hygienic and safe.

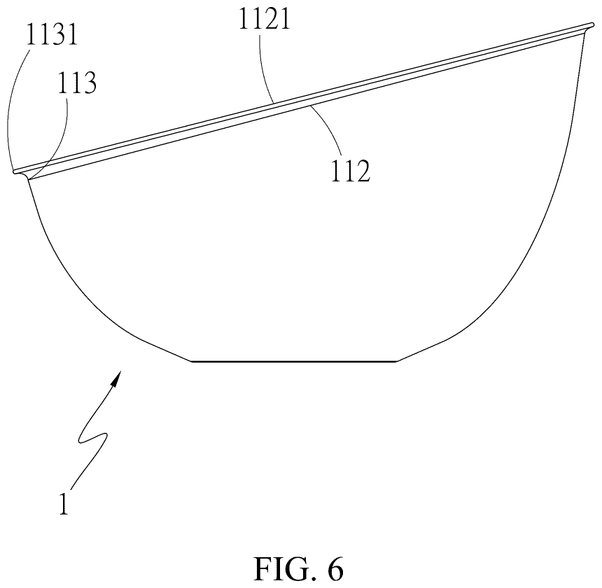

Referring to FIG. 6, which is a schematic view showing implementation of a fourth preferred embodiment of the present invention, it is clearly seen from the drawing that the instant embodiment is different from the first preferred embodiment in that in the instant embodiment, the oblique edge portions 112 are formed with an oblique edge fold portion 1121, and the low edge portion 113 is formed with a low edge fold portion 1131, and the oblique edge fold portion 1121 and the low edge fold portion 1131 are formed by folding an originally-existing upper edge of the circumferential wall of the food container 1 directly outwards in an integral manner to thereby form the oblique edge fold portion 1121 and the low edge fold portion 1131. With the arrangement of the oblique edge fold portion 1121 and the low edge fold portion 1131, it is less likely to cause accidents that the edge of the food container 1 cuts a user, and the sense of gripping is also improved.

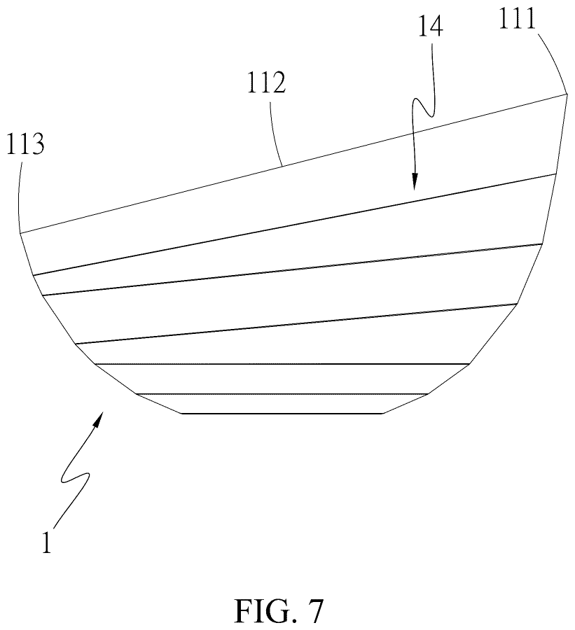

Referring to FIG. 7, which is a schematic view showing implementation of a fifth preferred embodiment of the present invention, it is clearly seen from the drawing that the instant embodiment is different from the first preferred embodiment in that in the instant embodiment, the circumferential wall of the food container 1 is formed with a pattern portion 14. The pattern portion 14 can be any form, and in the instant embodiment, multiple inclined line patterns are taken as an example, and each of the adjacent inclined line patterns is different with respect to the inclination thereof, so that the area between the inclined line patterns is different. In addition, the appearance and shape of the pattern portion 14 are arranged to correspond to the high edge portion 111, the oblique edge portions 112, and the low edge portion 113, so that the appearance has a smooth visual sense, and overall aesthetics reaches another different level, helping to enhance the aesthetics of the overall home space. Further, when a user takes the food container 1, because the pattern portion 14 forms multiple fold lines on the surface of the food container 1, an effect of slip prevention is achieved, and the convenience for the user to take is also increased.

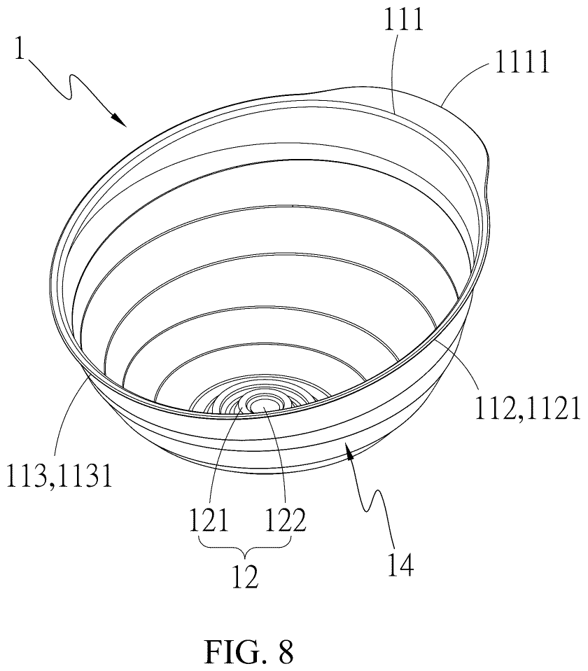

Referring to FIG. 8, which is a schematic view showing implementation of a sixth preferred embodiment of the present invention, it is clearly seen from the drawing that the instant embodiment is different from the previous preferred embodiments in that the instant embodiment combines most the above-described technical features. In other words, the upper edge of the food container 1 of the instant embodiment comprises a high edge portion 111, an oblique edge portion 112, and a low edge portion 113, and at least one layered portion 12 is provided on the bottom of the interior, and the layered portion 12 comprises an upper layer 121 and a lower layer 122, and the high edge portion 111 is formed with a high edge handle portion 1111, and the oblique edge portion 112 is formed with an oblique edge fold portion 1121, and the low edge portion 113 is formed with a low edge fold portion 1131, and a pattern portion 14 is formed on a circumferential wall of the food container 1. As such, the instant embodiment combines each of the previous embodiments and reaches an advantage that the overall use of the food container 1 is closer to a state of daily use by the user, and also helps to improve the aesthetics of the overall home space, thereby improving marketing and sales and effectively promoting industrial competitiveness.

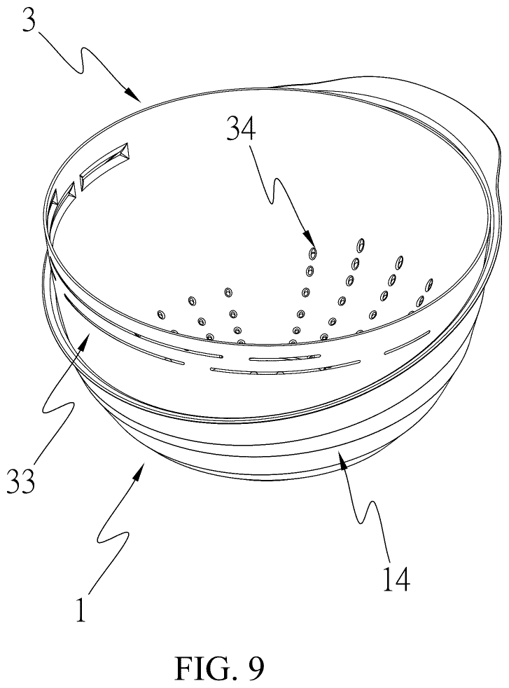

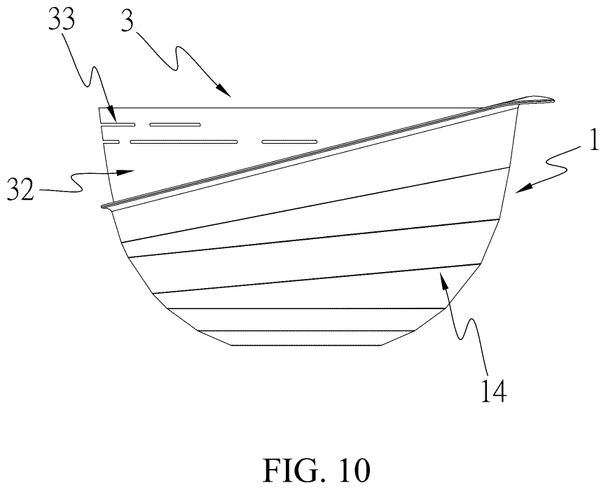

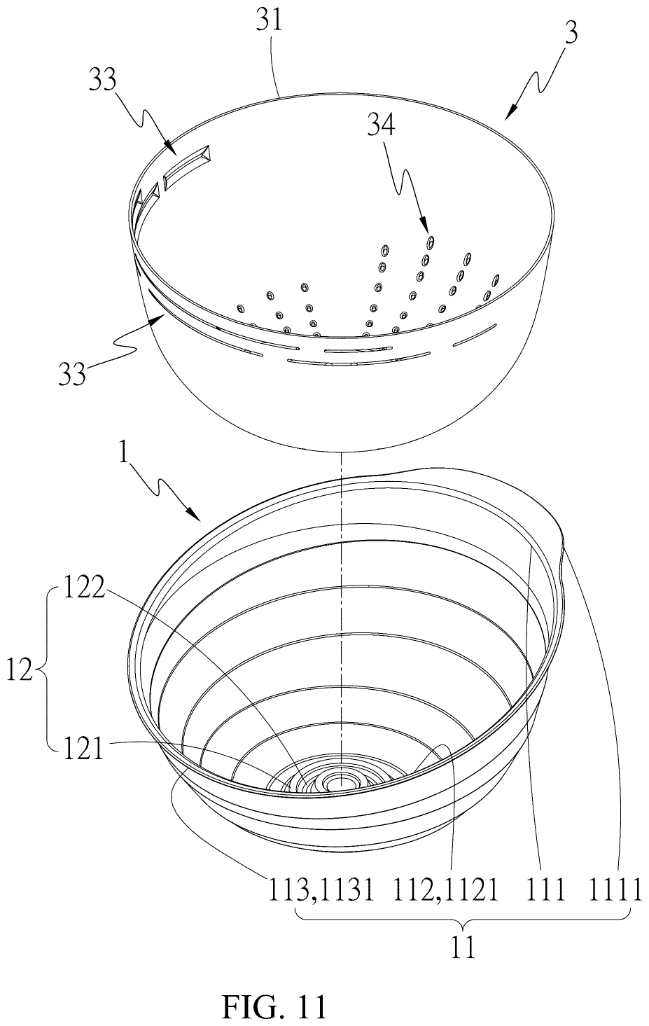

Referring to FIGS. 9-14, which are respectively a perspective view of a seventh preferred embodiment of the present invention, a side elevational view of the seventh preferred embodiment of the present invention, an exploded view of the seventh preferred embodiment of the present invention, a schematic view of the seventh preferred embodiment of the present invention illustrating washing, a schematic view of the seventh preferred embodiment of the present invention illustrating draining, and a schematic view of the seventh preferred embodiment of the present invention illustrating separating, it is clearly seen from the drawings that the embodiment comprises:
a food container 1, wherein the food container 1 has an upper edge 11, the upper edge 11 comprising a high edge portion 111, a plurality of oblique edge portions 112 formed by respectively extending from two ends of the high edge portion 111 toward a side opposite to the high edge portion 111, and a low edge portion 113 formed at intersection of each of the oblique edge portions 112, the low edge portion 113 having a height lower than the high edge portion 111, and the low edge portion 113 is formed with a low edge fold portion 1131, and the oblique edge portions 112 are formed with an oblique edge fold portion 1121, and the high edge portion 111 is provided with a high edge handle portion 1111;
at least one layered portion 12, which is formed on a bottom of an interior of the food container 1, the layered portion 12 comprising an upper layer 121 that supports food thereon and a lower layer 122 arranged below the upper layer 121, the lower layer 122 being arranged for collecting waste water that remains after the food is washed;
a drain container 3, which is positionable on the upper layer 121 of the layered portion 12, the drain container 3 being formed with a layout area 32 between an upper edge 31 thereof and the upper edge 11 of the food container 1;
a plurality of first drainage holes 33, which are formed in the layout area 32;
a plurality of second drainage holes 34, which are formed in a bottom of the drain container 3; and
a pattern portion 14, which is formed on a circumferential wall of the food container 1.

In the above, the first drainage holes 33 being made in the form of elongated holes is taken as an example in the instant embodiment, and is arranged horizontally. However, the configuration of the first drainage holes 33 is not limited and may be in the form of a circular hole, a polygon, or a curved shape.

In the above, the second drainage holes 34 being made in the form of circular hole is taken as an example in the instant embodiment, and an arrangement of extending in a radiating form from the center of the bottom of the food container 1 toward the periphery is provided as an example, so that with such a radiating arrangement, residual water 2 near the center can be quickly discharged, and residual water 2 far from the center can also be smoothly discharged from the second drainage holes 34 at the periphery of the radiating arrangement.

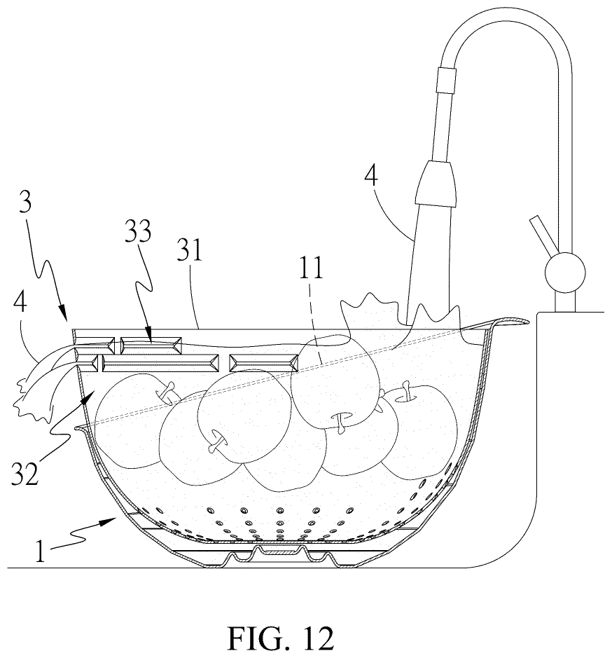

A user, when attempting to wash food, as shown FIG. 12, may combine the drain container 3 with the food container 1 and places the food in the drain container 3. At this time, a water source 4 can be turned on to rinse the food. Since the first drainage holes 33 are located in the layout area 32 that is between the upper edge 31 of the drain container 3 and the upper edge 11 of the food container 1, the water source 4 will be discharged from the first drainage holes 33 first and will not be discharged from the upper edge 31 of the drain container 3. Further, due to the layout area 32, the first drainage holes 33 can be arranged with an extreme great degree of freedom, and the first drainage holes 33 can be formed within the range of the layout area 32 as desired, and in the instant embodiment, the first drainage holes 33 being formed at a location closer to the top of the layout area 32 is provided as an example. In this way, the food can be prevented from falling out of the drain container 3 due to the water source 4 overflowing the upper edge 31 of the drain container 3, causing the food to be damaged or contaminated. In addition, the user can also use the water source r to continuously rinse the food so that the pesticides on the surface of the food can be brought away from the first drainage holes 33 with the water source 4, achieving the purpose of effectively removing pesticides.

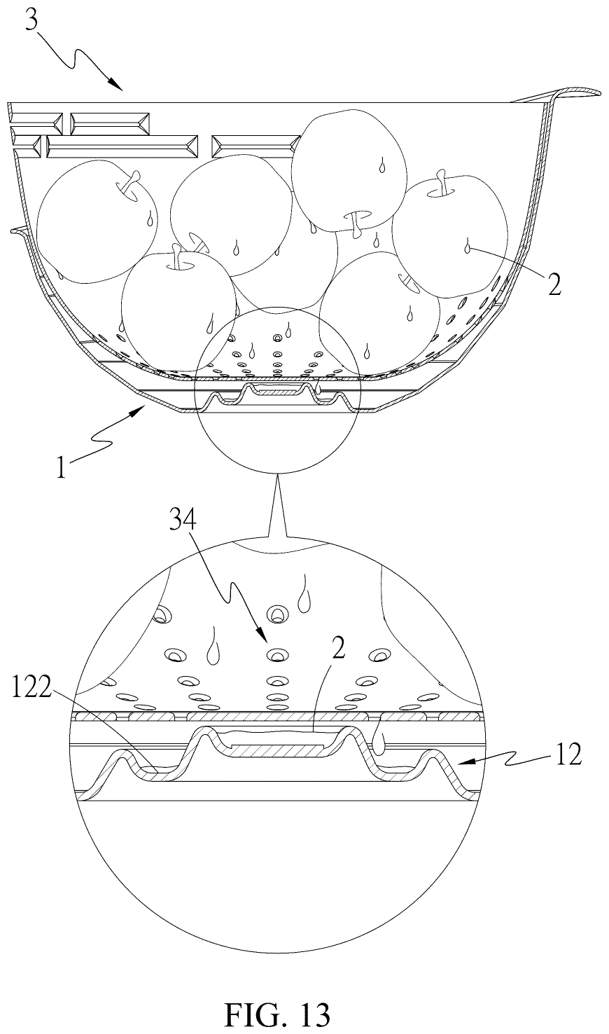

Further, when the food is to be drained after washing, as shown in FIG. 13, the residual water 2 in the food container 1 can be poured first, and then the drain container 3 containing the food therein is combined with the food container 1. Under this condition, there is certain residual water 2 remaining on the food, and such residual water 2 will flow from the food to the second drainage holes 34 at the bottom of the drain container 3, and then flow through the second drainage holes 34 to the lower layer 122 of the layered portion 12 to be collected there. Obviously, even if the food is placed in the drain container 3, it will not be contaminated by the dripping residual water 2, and the layered separation design is achieved, that is, there will be no secondary contamination problem.

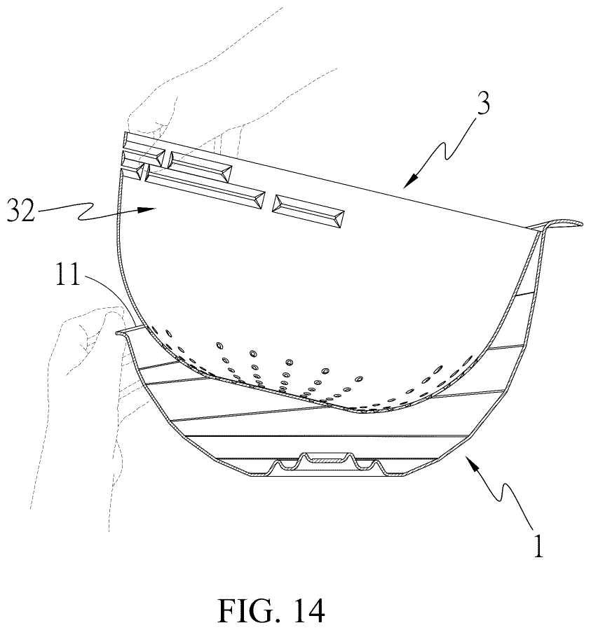

Furthermore, when the user wants to separate the food container 1 from the drain container 3, as shown in FIG. 14, the user can use one hand to hold the upper edge 11 of the food container 1, and the other hand holds the layout area 32 of the drain container 3 and then applies a force to separate the food container 1 from the drain container 3. The entire operation is simple and easy, saving effort and time, and there is no need to use fingernails or other tools to penetrate into the gap between the upper edges of the two to separate them as required in the prior art technology. That is, the present invention has the advantage of not using fingernails or tools to separate the food container 1 from the drain container 3.

In addition, due to the large area design of the layout area 32, the first drainage holes 33 have more freedom in the position arrangement during the manufacturing process, including quantity, arrangement height, and appearance. Horizontal arrangement is taken as an example in the instant embodiment.

Thus, when the user only needs to hold food as a fruit tray, the food container 1 can be used alone to hold food (such as fruits), and it also has the advantage of preventing secondary contamination. If the user needs to wash the food, the drain container 3 can be added and the food can be placed in the drain container 3 for washing. The waste water generated after washing can be discharged downward from the second drainage holes 34 to be used as a drain basket. After washing, the food can also be still kept in the drain container 3 for being combined with the food container 1 for draining, so that the residual water 2 can drip to the lower layer 122 for collection. Obviously, the present invention can be used in various ways through use in combination according to the needs of the user to achieve the advantage of being multifunctional.

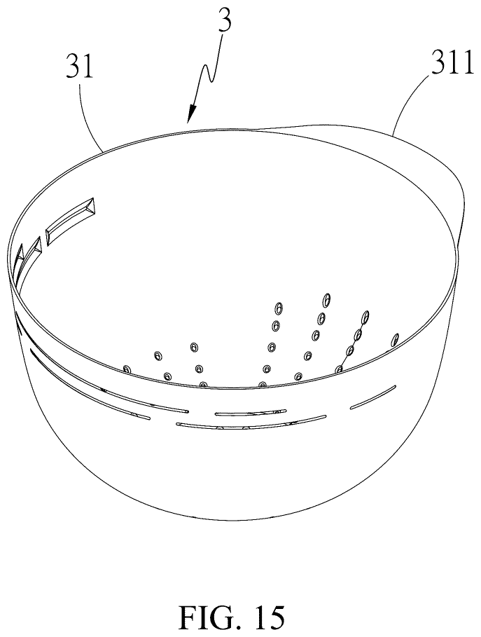

Referring to FIG. 15, which is a schematic view showing a drain container according to an eighth preferred embodiment of the present invention, it is clearly seen from the drawing that the instant embodiment is different from the seventh preferred embodiment in that in the instant embodiment, the upper edge 31 of the drain container 3 is provided with an upper edge handle portion 311, and the upper edge handle portion 311 is a planar surface formed by extending toward one side. With such an arrangement of the upper edge handle portion 311, a user, attempting to take the drain container 3, may take the drain container 3 without having a hand reach into the interior thereof. Overall, it is not only easier to take, but also hygienic and safe.

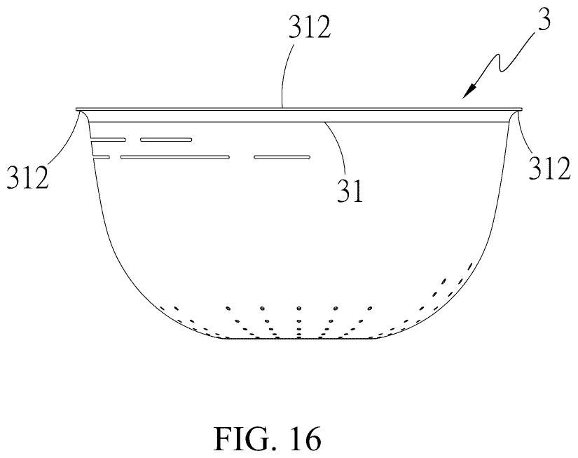

Referring to FIG. 16, which is a schematic view showing a drain container according to a ninth preferred embodiment of the present invention, it is clearly seen from the drawing that the instant embodiment is different from the seventh preferred embodiment in that in the instant embodiment, the upper edge 31 of the drain container 3 is formed with an upper edge fold portion 312, and the upper edge fold portion 312 is formed by folding the originally-existing upper edge 31 of the drain container 3 directly outwards in an integral manner. With such an arrangement of the upper edge fold portion 312, it is less likely to cause accidents that the edge of the drain container 3 cuts a user, and the sense of gripping is also improved.

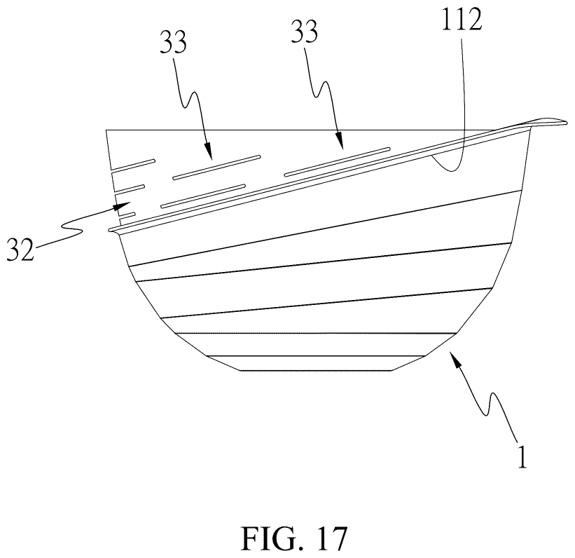

Referring to FIG. 17, which is a schematic view showing a drain container according to a tenth preferred embodiment of the present invention, it is clearly seen from the drawing that the instant embodiment is different from the seventh preferred embodiment in that in the instant embodiment, the first drainage holes 33 are in the form of elongated holes and are arranged in an inclined way. Obviously, due to the layout area 32, the arrangement position, shape, and quantity of the first drainage holes 33 are not limited, both horizontal arrangement and inclined arrangement being feasible, and vertical arrangement or staggered arrangement being even also feasible. Particularly, in case that the first drainage holes 33 are in the shape of elongated holes and arranged in an inclined way, a smooth visual design can be formed as echoing each other with respect to the oblique edge portions 112 of the food container 1, so as to fully highlight the overall aesthetics of the combination. Therefore, the layout area 32 allows the freedom of the arrangement of the first drainage holes 33 to be greatly improved, while still maintaining the original function of draining. This is an advantage that the conventional technology cannot achieve.

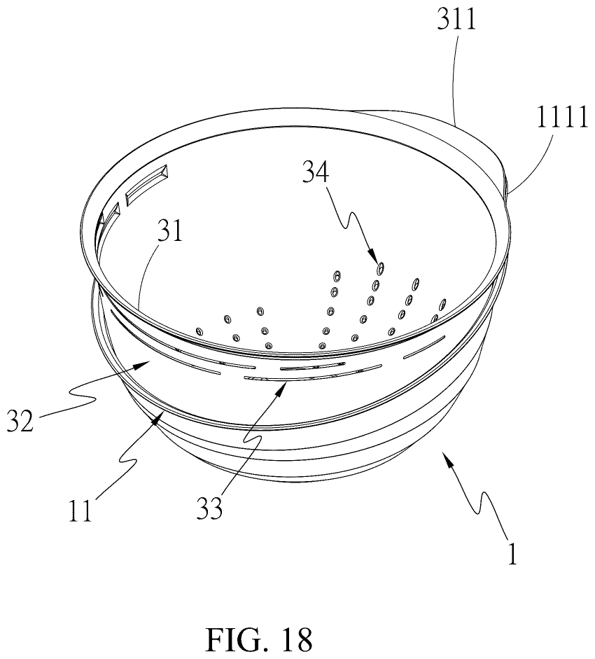

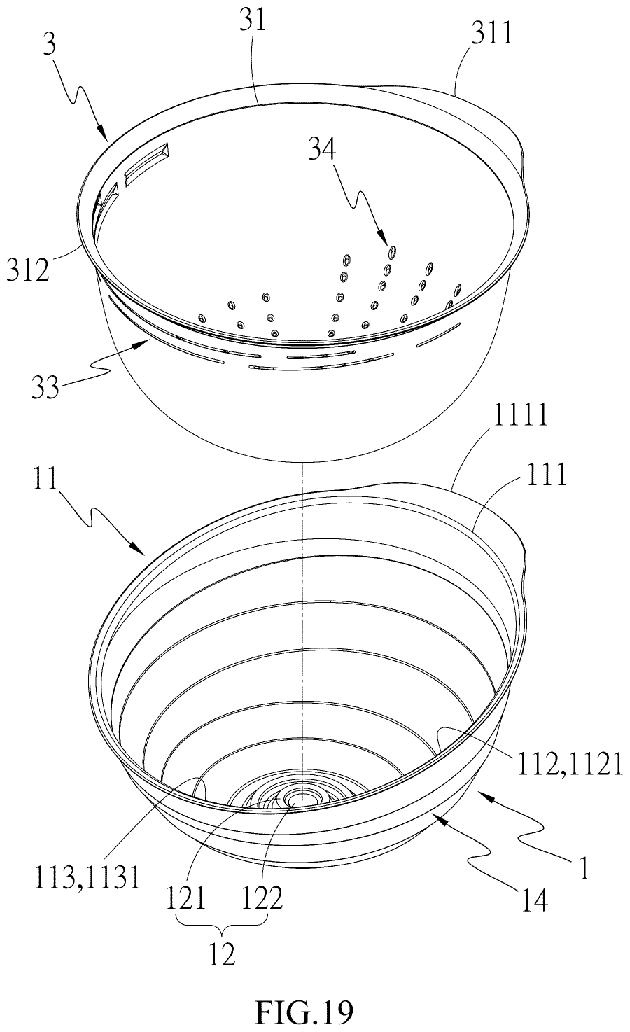

Referring to FIGS. 18 and 19, which are respectively a perspective view and an exploded view of an eleventh preferred embodiment of the present invention, it is clearly seen from the drawings that the instant embodiment is different from each of the previous preferred embodiments in that the instant embodiment combines most the above-described technical features. In other words, the upper edge of the food container 1 of the instant embodiment comprises a high edge portion 111, an oblique edge portion 112, and a low edge portion 113, and at least one layered portion 12 is provided on the bottom of the interior, and the layered portion 12 comprises an upper layer 121 and a lower layer 122, and the high edge portion 111 is formed with a high edge handle portion 1111, and the oblique edge portion 112 is formed with an oblique edge fold portion 1121, and the low edge portion 113 is formed with a low edge fold portion 1131, and a pattern portion 14 is formed on a circumferential wall of the food container 1, and additionally, a drain container 3 is arranged on the upper layer 121 of the layered portion 12, and the drain container 3 is formed with a layout area 32 between an upper edge 31 thereof and the upper edge 11 of the food container 1, and a plurality of first drainage holes 33 are formed in the layout area 32, and a plurality of second drainage holes 34 are formed in a bottom of the drain container 3, and the upper edge 31 of the drain container 3 is provided with an upper edge handle portion 311 and an upper edge fold portion 312. As such, the instant embodiment combines each of the previous embodiments and reaches an advantage that the overall use of the food container 1 and the drain container 3 is closer to a state of daily use by the user, and also helps to improve the aesthetics of the overall home space, thereby improving marketing and sales and effectively promoting industrial competitiveness.

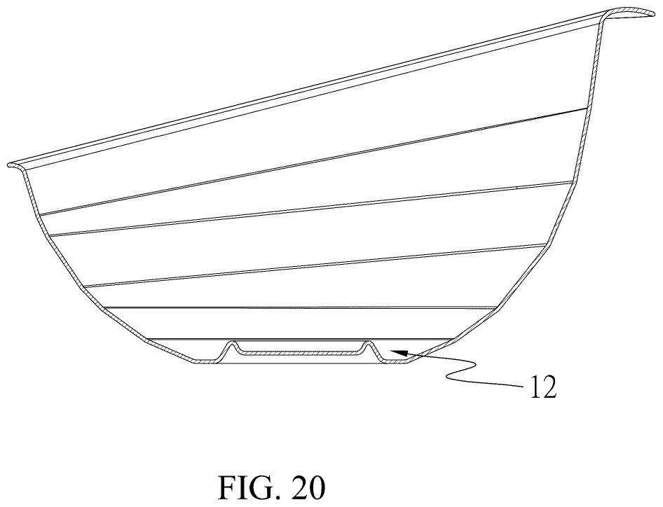

Referring to FIG. 20, which is a schematic view showing a layered portion of a twelfth preferred embodiment of the present invention, it is clearly seen from the drawing that the instant embodiment is different from the seventh preferred embodiment in that in the instant embodiment, the layered portion 12 is changed from multiple to a single one, and is made in the form of a circle. This means that the layered portion 12 of the present invention can be one or multiple, all within the scope of protection of the present invention, and the arrangement of a single layered portion 12 can still collect the residual water without losing the original function.

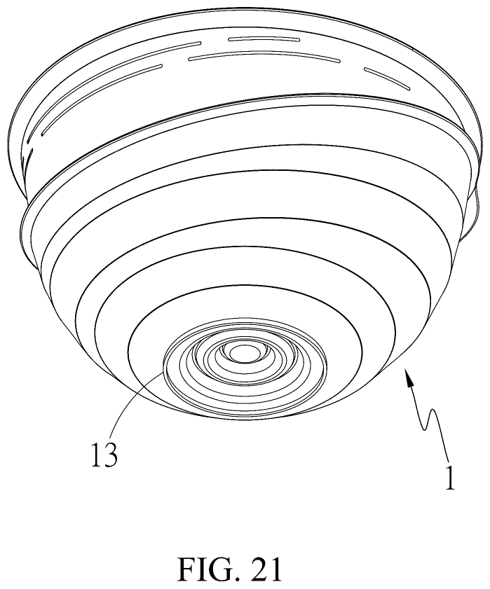

Referring to FIG. 21, which is schematic view showing a stabilizing portion of a thirteenth preferred embodiment of the present invention, it is clearly seen from the drawing that the instant embodiment is different from the second preferred embodiment in that in the instant embodiment, the stabilizing portion 13 is changed from multiple ones to a single one, and an arrangement of circling around the bottom of the food container 1 is taken as an example of illustration. This means that the stabilizing portion 13 of the present invention can be one or multiple, all within the scope of protection of the present invention.

I claim:

1. A multifunctional food container, mainly comprising:
a food container, wherein the food container has an upper edge, the upper edge comprising a high edge portion, a plurality of oblique edge portions formed by respectively extending from two ends of the high edge portion toward a side opposite to the high edge portion, and a low edge portion formed at an intersection of each of the oblique edge portions, the low edge portion having a height lower than the high edge portion; and
at least one layered portion, which is formed on a bottom of an interior of the food container, the layered portion comprising an upper layer for supporting food thereon and a lower layer arranged below the upper layer, the lower layer being arranged for collecting waste water that remains after the food is washed.

2. The multifunctional food container according to claim 1, wherein a bottom of an outside of the food container is provided with at least one stabilizing portion.

3. The multifunctional food container according to claim 1, wherein the high edge portion is provided with a high edge handle portion.

4. The multifunctional food container according to claim 1, wherein the oblique edge portions are formed with an oblique edge fold portion, and the low edge portion is formed with a low edge fold portion.

5. The multifunctional food container according to claim 1, wherein a circumferential wall of the food container is formed with a pattern portion.

6. A multifunctional food container, mainly comprising:
a food container, wherein the food container has an upper edge, the upper edge comprising a high edge portion, a plurality of oblique edge portions formed by respectively extending from two ends of the high edge portion toward a side opposite to the high edge portion, and a low edge portion formed at an intersection of each of the oblique edge portions, the low edge portion having a height lower than the high edge portion;
at least one layered portion, which is formed on a bottom of an interior of the food container, the layered portion comprising an upper layer and a lower layer arranged below the upper layer, the lower layer being arranged for collecting waste water that remains after the food is washed;
a drain container, which is arranged on the upper layer of the layered portion, a layout area being formed between an upper edge of the drain container and the upper edge of the food container;
a plurality of first drainage holes, which are formed in the layout area; and
a plurality of second drainage holes, which are formed in a bottom of the drain container.

7. The multifunctional food container according to claim 6, wherein a bottom of an outside of the food container is provided with at least one stabilizing portion.

8. The multifunctional food container according to claim 6, wherein the high edge portion is provided with a high edge handle portion.

9. The multifunctional food container according to claim 6, wherein the oblique edge portions are formed with an oblique edge fold portion, and the low edge portion is formed with a low edge fold portion.

10. The multifunctional food container according to claim 6, wherein a circumferential wall of the food container is formed with a pattern portion.

11. The multifunctional food container according to claim 6, wherein the upper edge of the drain container is provided with an upper edge handle portion.

12. The multifunctional food container according to claim 6, wherein the upper edge of the drain container is formed with an upper edge fold portion.

13. The multifunctional food container according to claim 6, wherein each of the first drainage holes is in the form of one of an elongated hole, a circular hoe, a polygon, and a curved shape.

14. The multifunctional food container according to claim 13, wherein each of the first drainage holes is of a configuration of one of horizontal arrangement, vertical arrangement, inclined arrangement, or staggered arrangement.
